(19) United States
(12) Patent Application Publication
(10) Pub. No.: US 2026/0364940 A1
(43) Pub. Date: Nov. 19, 2026

(54) INKJET PRINTING APPARATUS

(71) Applicant: SCREEN Holdings Co., Ltd., Kyoto (JP)

(72) Inventor: Tomoyasu OKUSHIMA, Kyoto-shi, Kyoto (JP)

(21) Appl. No.: 19/514,972

(22) PCT Filed: Jun. 25, 2024
(86) PCT No.: PCT/JP2024/023000

§ 371 Date: Feb. 27, 2026

(30) Foreign Application Priority Data
Aug. 31, 2023 (JP) 2023-141002

(51) Int. Cl. B41J 2/045

(52) U.S. Cl. CPC B41J 2/04588; B41J 2/04541; B41J 2/04563; B41J 2/04581

(57) ABSTRACT

The discharge unit discharges an ink droplet onto a printing medium conveyed by a conveyance mechanism. The detection unit detects a speed at which the printing medium is conveyed. In a case where a speed at which the printing medium is conveyed changes exceeding a first threshold value, in a predetermined period including the time point, a drive signal generation unit generates a drive signal for driving a piezoelectric element of a discharge unit by multiplying a mixed waveform in which a pre-change fundamental waveform that is a fundamental waveform corresponding to a speed at which the printing medium is conveyed before the conveying speed is changed and a post-change fundamental waveform that is the fundamental waveform corresponding to a speed at which the printing medium is conveyed after the conveying speed is changed are mixed, by an image signal.

### TECHNICAL FIELD

The present invention relates to an inkjet printing apparatus that performs printing on a printing medium such as paper with an inkjet method.

### BACKGROUND ART

Conventionally, there has been known an inkjet printing apparatus that prints text and images by discharging ink droplets onto a printing medium being conveyed in a predetermined direction. Such a printing apparatus includes a discharge unit that discharges ink droplets, and a control unit that generates drive signals for driving the discharge unit.

When performing printing by using the inkjet printing apparatus, a speed at which a printing medium is conveyed may change. Furthermore, temperature of ink that is not discharged yet and stored in a discharge unit may change. Thus, when a situation at a time of discharge changes, waveforms of the drive signals to be supplied to the discharge unit are usually switched according to the changed situation. Here, when the waveforms of the drive signal are switched, density of the ink printed on the printing medium as a print result may change at a switching boundary, and the boundary may appear as a streak. Therefore, a technique as a measure against such an event is disclosed in, for example, Patent Literature 1.

### CITATION LIST

### Patent Literature

### Patent Literature 1

Japanese Patent No. 5268838

### SUMMARY OF INVENTION

### Technical Problem

Patent Literature 1 discloses a technique as a measure against an event in which, in a case where a piezoelectric element, which is an actuator for ink discharge, in an inkjet head does not operate for a long period of time, ink droplets are less likely to be discharged due to an effect of ink thickening or the like. In particular, it is pointed out that when the discharge is resumed after a non-operation period of an actuator, a speed at which a first ink droplet is discharged is slower, causing a large difference in speed at which subsequent ink droplets of each ink (paragraph 0003) are discharged.

Therefore, in Patent Literature 1, when drive pulse voltages for actuators (Z1, Z2, . . . Zm) are generated, a level of a first to a predetermined number of drive pulse voltages is set higher than a level of the other drive pulse voltages. Furthermore, the level of the predetermined number of drive pulse voltages is gradually changed in a reduction direction (paragraph 0026). As a result, the discharge speed can be increased even when the ink is in a thickened state (paragraph 0029).

However, when the level of the predetermined number of drive pulse voltages is gradually changed in the reduction direction, the level of the drive pulse voltage after the change may have an unprecedented value or shape. Furthermore, in general, in a discharge unit, in a case where a drive pulse voltage (drive signal) supplied to a piezoelectric element has a certain value or waveform (frequency), ink droplets may not be discharged well, or a discharge position may deviate. That is, the method in Patent Literature 1 does not ensure that ink droplets are appropriately discharged.

The present invention has been made in view of such circumstances, and an object thereof is to provide a technique capable of, when switching waveforms of drive signals to be supplied to a discharge unit according to a change in situation at a time of discharge, appropriately discharging ink droplets, making a switching boundary inconspicuous, and thus improving print quality.

### Solution to Problem

In order to solve the problems described above, a first invention of the present application is an inkjet printing apparatus that performs printing on a printing medium with an inkjet method, and includes a conveyance mechanism, an encoder, a discharge unit, a drive signal generation unit, an image signal supply unit, a detection unit, a fundamental-waveform storage unit, and a fundamental-waveform selection unit. The conveyance mechanism conveys the printing medium in a longitudinal direction along a conveyance path. The encoder outputs a pulse signal corresponding to a speed at which the printing medium conveyed by the conveyance mechanism is conveyed. The discharge unit includes a nozzle that discharges, at a discharge position on the conveyance path, an ink droplet onto the printing medium conveyed by the conveyance mechanism, an ink chamber communicating with the nozzle, and a piezoelectric element that applies pressure to ink in the ink chamber. The drive signal generation unit generates a drive signal for driving the piezoelectric element and supplies the drive signal to the discharge unit. The image signal supply unit generates, based on information of position of the printing medium, the information of position being detected from the pulse signal output from the encoder, an image signal representing an image to be printed at the discharge position, and supplies the image signal to the drive signal generation unit. The detection unit detects one of a speed at which the printing medium related to the pulse signal is conveyed or a temperature of ink in the ink chamber. The fundamental-waveform storage unit stores a variable range of values of the one of a speed at which the printing medium is conveyed or a temperature of ink in the ink chamber, and a fundamental waveform corresponding to this in association with each other. The fundamental-waveform selection unit reads the fundamental waveform from the fundamental-waveform storage unit based on a result of detecting, by the detection unit, the one of a speed at which the printing medium is conveyed or a temperature of ink in the ink chamber, and supplies the fundamental waveform to the drive signal generation unit. In a case where the one of a speed at which the printing medium is conveyed or a temperature of ink in the ink chamber changes exceeding a first threshold value, in a predetermined period including the time point, the drive signal generation unit generates the drive signal by multiplying a mixed waveform in which a pre-change fundamental waveform that is the fundamental waveform corresponding to the one of a speed at which the printing medium is conveyed before the conveying speed is changed or a temperature of ink in the ink chamber before the temperature is changed and a post-change fundamental waveform that is the fundamental waveform corresponding to the one of a speed at which the printing medium is conveyed after the conveying speed is changed or a temperature of ink in the ink chamber after the temperature is changed are mixed, by the image signal, and supplies the drive signal to the discharge unit.

A second invention of the present application is the inkjet printing apparatus of the first invention, in which the drive signal generation unit generates the drive signal by multiplying the mixed waveform in which the pre-change fundamental waveform and the post-change fundamental waveform are mixed at a predetermined mixture ratio, by the image signal.

A third invention of the present application is the inkjet printing apparatus of the first invention or the second invention, in which, in a case where the one of a speed at which the printing medium is conveyed or a temperature of ink in the ink chamber changes exceeding the first threshold value, and then further changes exceeding a second threshold value, the predetermined period is a period before a middle of a period from a time point at which the one of a speed at which the printing medium is conveyed or a temperature of ink in the ink chamber changes exceeding the first threshold value to a time point at which the one of the speed at which the printing medium is conveyed or the temperature of ink in the ink chamber further changes exceeding the second threshold value.

A fourth invention of the present application is the inkjet printing apparatus of the second invention, in which, in the predetermined period, the mixture ratio changes such that a proportion of the pre-change fundamental waveform gradually decreases and a proportion of the post-change fundamental waveform gradually increases.

A fifth invention of the present application is the inkjet printing apparatus of any one of the first to fourth inventions, in which the one is a speed at which the printing medium is conveyed.

A sixth invention of the present application is the inkjet printing apparatus of any one of the first to fourth inventions, in which the one is a temperature of ink in the ink chamber.

### Advantageous Effects of Invention

According to the first to sixth inventions of the present application, in a case where waveforms of drive signals supplied to the discharge unit are switched according to a change in situation at a time of discharge, the drive signals are generated by using the mixed waveform in which the pre-change fundamental waveform and the post-change fundamental waveform are mixed. As a result, a switching boundary is inconspicuous, and print quality can be improved. Furthermore, because the pre-change fundamental waveform and the post-change fundamental waveform are mixed without changing the fundamental waveforms themselves, the ink droplet can be appropriately discharged as compared with a case where the fundamental waveforms themselves are changed.

### BRIEF DESCRIPTION OF DRAWINGS

FIG. 1 is a diagram conceptually showing a configuration of an inkjet printing apparatus according to a first embodiment.

FIG. 2 is a diagram of one discharge unit according to the first embodiment as viewed from below.

FIG. 3 is a diagram conceptually showing a configuration of one discharge unit and one ink supply unit according to the first embodiment.

FIG. 4 is a block diagram showing an electrical connection between a control unit and each unit in the inkjet printing apparatus according to the first embodiment.

FIG. 5 is a block diagram conceptually showing some functions in the control unit according to the first embodiment.

FIG. 6 is a diagram showing an example of fundamental waveforms stored in a fundamental-waveform storage unit according to the first embodiment.

FIG. 7 is a diagram for describing switching of waveforms according to the first embodiment.

FIG. 8 is a diagram showing an example of a ratio between the number of pre-change fundamental waveforms and the number of post-change fundamental waveforms, the ratio being included in mixed waveform stored in a mixture ratio storage unit according to the first embodiment.

FIG. 9 is a diagram conceptually showing a configuration of one discharge unit and one ink supply unit according to a second embodiment.

FIG. 10 is a block diagram conceptually showing some functions in a control unit according to the second embodiment.

FIG. 11 is a diagram showing an example of fundamental waveforms stored in a fundamental-waveform storage unit according to the second embodiment.

FIG. 12 is a diagram for describing switching of waveforms according to the second embodiment.

### DESCRIPTION OF EMBODIMENTS

Hereinafter, embodiments according to the present invention will now be described with reference to the drawings. Note that components described in these embodiments are mere examples and are not intended to limit the scope of the present invention to those only. Furthermore, in the drawings, for the purpose of easier understanding, the dimensions or the number of respective units are overstated or understated in some portions of illustration, as necessary.

### 1. First Embodiment

### 1-1. Configuration of Inkjet Printing Apparatus

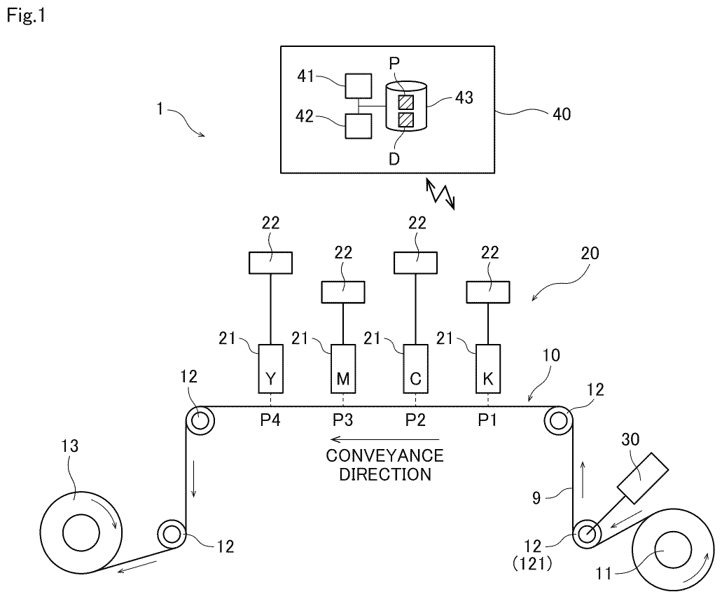

FIG. 1 is a diagram conceptually showing a configuration of an inkjet printing apparatus 1 according to a first embodiment of the present invention. The inkjet printing apparatus 1 is an inkjet printing machine that discharges water-based ink droplets from a plurality of discharge units 21 toward continuous paper 9 in a shape of a long strip while conveying the continuous paper 9, to record text and images on a recording surface of the continuous paper 9. Note that the continuous paper 9 in a shape of a long strip is just one example of a printing medium. The printing medium may be a cut sheet, a plastic film, cardboard, metal foil, a glass material, or the like. That is, the inkjet printing apparatus 1 is only required to be an apparatus that performs printing on a printing medium with an inkjet method. As shown in FIG. 1, the inkjet printing apparatus 1 includes a conveyance mechanism 10, a printing unit 20, an encoder 30, and a control unit 40.

The conveyance mechanism 10 is a mechanism for conveying the continuous paper 9 in a conveyance direction extending along a longitudinal direction of the continuous paper 9. That is, the conveyance mechanism 10 conveys the continuous paper 9 in the longitudinal direction along a conveyance path. The conveyance mechanism 10 includes a plurality of rollers including an unwinding roller 11, a plurality of conveyance rollers 12, and a winding roller 13. The continuous paper 9 is placed on these plurality of rollers in a state where tension is applied. As a result, slack or wrinkles in the continuous paper 9 during the conveyance are reduced.

Furthermore, the conveyance mechanism 10 includes a motor (not shown) that rotates at least one roller among the plurality of conveyance rollers 12. Hereinafter, the roller is referred to as a “drive roller”. By driving the motor, each conveyance roller 12 including the drive roller rotates about an axis parallel to a width direction of the continuous paper 9. Here, the width direction is a direction perpendicular and horizontal to the conveyance direction. As a result, the continuous paper 9 is fed from the unwinding roller 11 and guided to downstream of the conveyance path constituted by the plurality of conveyance rollers 12. Furthermore, the continuous paper 9 after being conveyed is collected by the winding roller 13.

The printing unit 20 includes the plurality of discharge units 21 and a plurality of ink supply units 22. In the present embodiment, the printing unit 20 includes four discharge units 21 and four ink supply units 22. The four discharge units 21 are arranged at intervals along the conveyance direction of the continuous paper 9. The four discharge units 21 are arranged one by one above each of discharge positions P1, P2, P3, and P4 on the conveyance path. The four discharge units 21 have a structure equivalent to each other. Note that the continuous paper 9 moves substantially parallel to an arrangement direction of the four discharge units 21, below the four discharge units 21. Here, the recording surface of the continuous paper 9 is directed toward the discharge units 21. That is, the recording surface of the continuous paper 9 is directed upward.

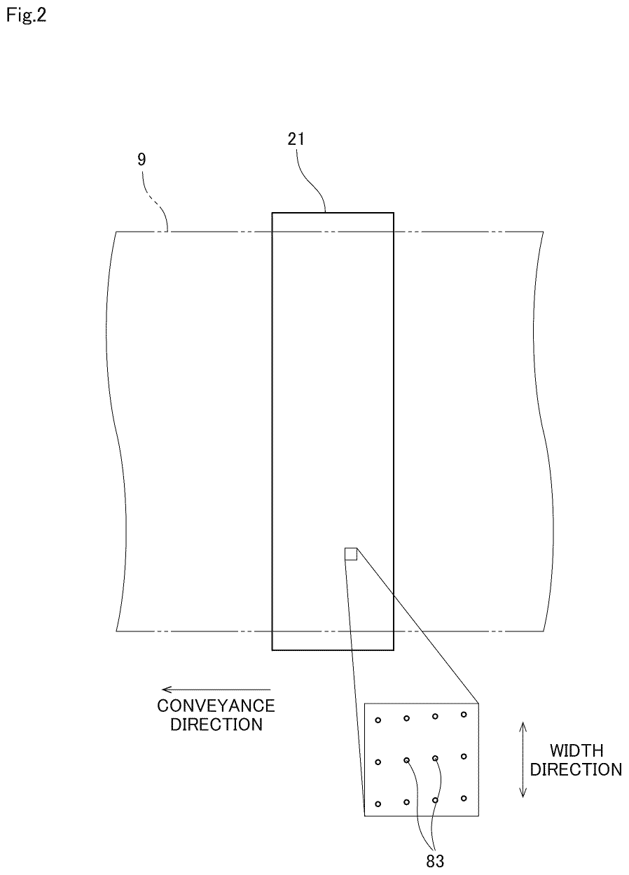

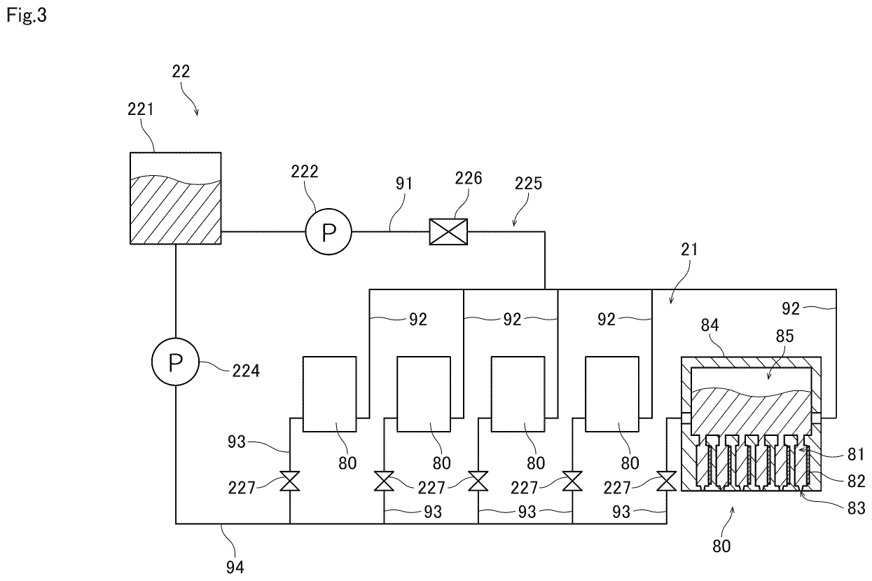

Each of the four discharge units 21 is a unit that discharges ink droplets from a nozzle 83 (refer to FIGS. 2 and 3 to be described later) toward the recording surface (upper surface) of the continuous paper 9 conveyed by the conveyance mechanism 10. In the present embodiment, the four discharge units 21 discharge ink droplets in different colors from each other, by which each of the four discharge units 21 records a single-color image on the recording surface of the continuous paper 9. In the present embodiment, for example, the four discharge units 21 discharge ink droplets in respective colors, cyan, magenta, yellow, and black. Then, the four single-color images are superimposed, so that a multicolor image is formed on the recording surface of the continuous paper 9.

FIG. 2 is a diagram of one discharge unit 21 as viewed from below. In FIG. 2, the continuous paper 9 is denoted by an imaginary line (dash-dot-dot line). As shown in an enlarged manner in FIG. 2, a plurality of nozzles 83 capable of discharging ink droplets are provided on a lower surface of the discharge unit 21. In the present embodiment, the plurality of nozzles 83 are two-dimensionally arranged in the conveyance direction and the width direction on the lower surface of the discharge unit 21. Furthermore, the nozzles 83 are arranged with positions thereof shifted in the width direction. Thus, by two-dimensionally arranging the plurality of nozzles 83 in this manner, the positions of the nozzles 83 in the width direction can be brought close to each other. However, the plurality of nozzles 83 may be arranged in a line along the width direction.

FIG. 3 is a diagram conceptually showing a configuration of one discharge unit 21 and one ink supply unit 22. In the present embodiment, each discharge unit 21 includes a plurality of heads 80 adjacent to each other. In the present embodiment, each discharge unit 21 includes five heads 80. The five heads 80 have a structure equivalent to each other. Hence, in FIG. 3, only one of the five heads 80 is shown in detail, and the other four heads 80 are shown in a simplified manner. As shown in FIG. 3, the nozzles 83 are holes provided in a lower portion of a head 80. The nozzles 83 face the recording surface (upper surface) of the continuous paper 9 conveyed by the conveyance mechanism 10 in a vertical direction. Furthermore, for one nozzle 83, the head 80 includes one ink chamber 81 and a piezoelectric element 82 as one actuator. Then, the head 80 includes a plurality of sets of a nozzle 83, an ink chamber 81, and a piezoelectric element 82.

Furthermore, an internal tank 85 is provided inside a housing 84 forming an outer frame of the head 80. The internal tank 85 is positioned above the plurality of nozzles 83 and the plurality of ink chambers 81, and is a space capable of temporarily storing ink. Each of the plurality of ink chambers 81 in one head 80 communicates with the internal tank 85. Furthermore, each ink chamber 81 is a cavity communicating with the nozzle 83. The piezoelectric element 82 is provided on a wall surface of the ink chamber 81.

During discharge of ink, ink flows down from the internal tank 85 to the ink chambers 81. Then, a drive signal Ds to be described later is supplied to the discharge unit 21. Here, the drive signal Ds is a signal obtained by linking in time series values representing drive voltages applied to the piezoelectric elements 82 to drive the piezoelectric elements 82. The drive voltages are pulsed waveforms. The piezoelectric elements 82 elongate toward inside of the ink chamber 81 in response to the supplied drive signal Ds. As a result, pressure is applied to the ink in the ink chamber 81. As a result, the ink droplets are discharged from the nozzles 83. That is, at the respective discharge positions P1 to P4 on the convey ance path of the continuous paper 9, the plurality of nozzles 83 of the plurality of discharge units 21 discharge the ink droplets onto the recording surface of the continuous paper 9 conveyed by the conveyance mechanism 10.

Furthermore, as described above, in response to the drive signal Ds, the four discharge units 21 discharge the ink droplets in different colors from each other, from the plurality of nozzles 83. The four discharge units 21 discharge the ink droplets in respective colors, cyan, magenta, yellow, and black, for example. Then, the multicolor image is recorded on the recording surface of the continuous paper 9 by superimposing the single-color images formed by the ink droplets in the respective colors.

Note that a drying processing unit that dries the ink discharged on the recording surface of the continuous paper 9 may be further provided downstream of the conveyance direction of the four discharge units 21. The drying processing unit, for example, blows a heated gas toward the continuous paper 9 to vaporize solvent in the ink attached to the continuous paper 9, thereby drying the ink. However, the drying processing unit may cure or dry the ink with another method such as light irradiation.

Next, a structure of an ink supply unit 22 will be briefly described. The ink supply unit 22 is a device configured to supply ink to a discharge unit 21 while circulating some of the ink. As described above, the inkjet printing apparatus 1 of the present embodiment includes the four ink supply units 22. Each of the four ink supply units 22 is connected to one discharge unit 21. The structures of the four ink supply units 22 are equivalent to each other.

As shown in FIG. 3, each ink supply unit 22 includes a storage tank 221, a supply pump 222, a return pump 224, a pipe 225, a filter 226, and a plurality of on-off valves 227. In the present embodiment, each ink supply unit 22 includes five on-off valves 227. The pipe 225 includes a first supply pipe 91, a plurality of second supply pipes 92, a plurality of first return pipes 93, and a second return pipe 94. In the present embodiment, the pipe 225 includes five second supply pipes 92 and five first return pipes 93.

The storage tank 221 is a container that stores ink. A temperature adjustment mechanism (not shown) for adjusting a temperature of stored ink is mounted on the storage tank 221. Furthermore, the storage tank 221 is connected to each head 80 of one discharge unit 21 via the first supply pipe 91 and the second supply pipes 92 each branching from the first supply pipe 91. Furthermore, the supply pump 222 and the filter 226 are provided on the first supply pipe 91.

According to an operation signal from the control unit 40, the supply pump 222 generates in the first supply pipe 91 a flow of ink from the storage tank 221 toward each head 80. As a result, the ink whose temperature has been adjusted while being stored in the storage tank 221 is supplied to the internal tanks 85 of the respective heads 80 via the first supply pipe 91 and the second supply pipes 92. Furthermore, the filter 226 removes solid components, foreign substances, and the like in the ink passing through the first supply pipe 91. As a result, mixing of the solid components and foreign substances into the ink supplied to each head 80 is suppressed.

Note that a liquid level sensor (not shown) is mounted on each head 80. The liquid level sensor is a sensor that detects a liquid level of the ink stored in an internal tank 85. The control unit 40 detects the liquid level of the ink in the internal tank 85 based on the signal from the liquid level sensor, and determines whether or not to supply the ink to the internal tank 85. Then, when supplying the ink from the storage tank 221 to the internal tank 85, the control unit 40 operates the supply pump 222.

The five first return pipes 93 and the second return pipe 94 are pipes connecting the five heads 80 and the storage tank 221. An on-off valve 227 is provided on each first return pipe 93. When the on-off valve 227 is in a closed state, communication of the first return pipe 93 on which the on-off valve 227 is provided is blocked. Meanwhile, when the on-off valve 227 is in an open state, communication of the first return pipe 93 on which the on-off valve 227 is provided is secured.

Furthermore, the return pump 224 is provided on the second return pipe 94. According to the operation signal from the control unit 40, the return pump 224 generates in the second return pipe 94 a flow of ink from each first return pipe 93 toward the storage tank 221. As a result, the ink stored in the internal tank 85 of the respective heads 80 is returned to the storage tank 221 via the first return pipes 93 and the second return pipe 94. Here, the ink stored in the internal tank 85 of each head 80 is ink that has a greatly lowered temperature by having remained in the internal tank 85, not been discharged for a long period of time. As a result, it is possible to suppress significant changes in the temperature (for example, about 10 °C or higher), viscosity, and the like of the ink stored in the internal tank 85 of each head 80. For example, the temperature stored in the internal tank 85 of each head 80 can be suppressed from changing by about 10 °C or more. As a result, deterioration of the ink discharged from each nozzle 83 can be suppressed, and print quality can be improved.

The encoder 30 is a sensor for detecting a speed at which the continuous paper 9 is conveyed. The encoder 30 is attached to a shaft core of one of the plurality of conveyance rollers 12. In the present embodiment, the encoder 30 is attached to a shaft core of a conveyance roller 121 in FIG. 1. The encoder 30 outputs a pulse signal En once every time the conveyance roller 121 rotates by a predetermined angle. Hence, the pulse signal En is data reflecting a temporal change in speed at which the continuous paper 9 conveyed by the plurality of conveyance rollers 12 including the conveyance roller 121 is conveyed. Therefore, when the continuous paper 9 is conveyed at a constant conveying speed, the encoder 30 outputs the pulse signal En that continues at a constant cycle corresponding to the conveying speed.

The pulse signal En is transmitted from the encoder 30 to the control unit 40. That is, to the control unit 40, the encoder 30 supplies the pulse signal En corresponding to the speed at which the continuous paper 9 conveyed by the conveyance mechanism 10 is conveyed. However, the encoder 30 is only required to be directly or indirectly connected to at least one of the plurality of conveyance rollers 12, and a destination of the connection is not limited to the conveyance roller 121.

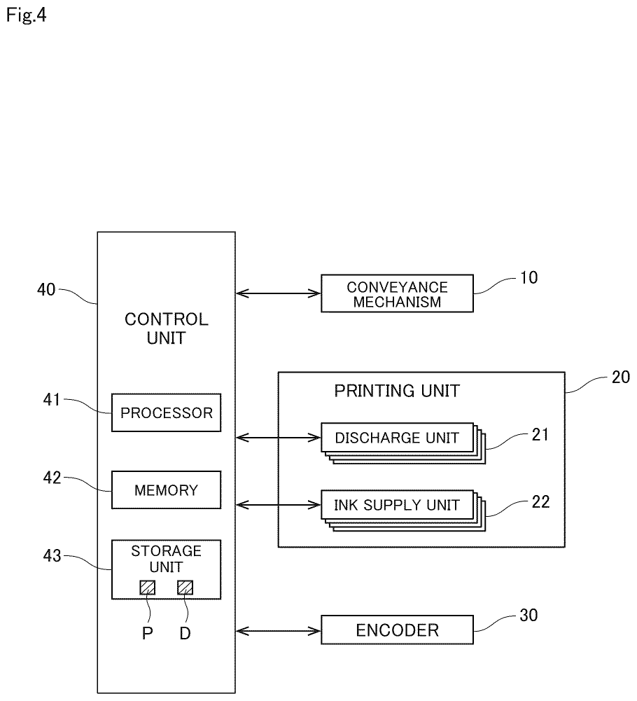

The control unit 40 is an information processing device for controlling operation of each unit in the inkjet printing apparatus 1. FIG. 4 is a block diagram showing an electrical connection between the control unit 40 and each unit in the inkjet printing apparatus 1. As shown in FIG. 4, the control unit 40 includes a computer including a processor 41 such as a CPU, a memory 42 such as a RAM, and a storage unit 43 such as a hard disk drive. The storage unit 43 stores a computer program P and data D for controlling operation of each unit and discharging ink droplets from the discharge units 21 onto the continuous paper 9 while conveying the continuous paper 9.

Furthermore, as shown in FIG. 4, the control unit 40 is connected to the convey ance mechanism 10, the four discharge units 21 of the printing unit 20, the four ink supply units 22 of the printing unit 20, and the encoder 30, so as to be able to communicate therewith by wire or wirelessly. The control unit 40 reads the computer program P and the data D from the storage unit 43 to the memory 42, and operates the processor 41 according to the computer program P and the data D. As a result, the conveyance of the continuous paper 9 and processing of printing the continuous paper 9 proceed.

### 1-2. Detailed Configuration of Functions of Control Unit

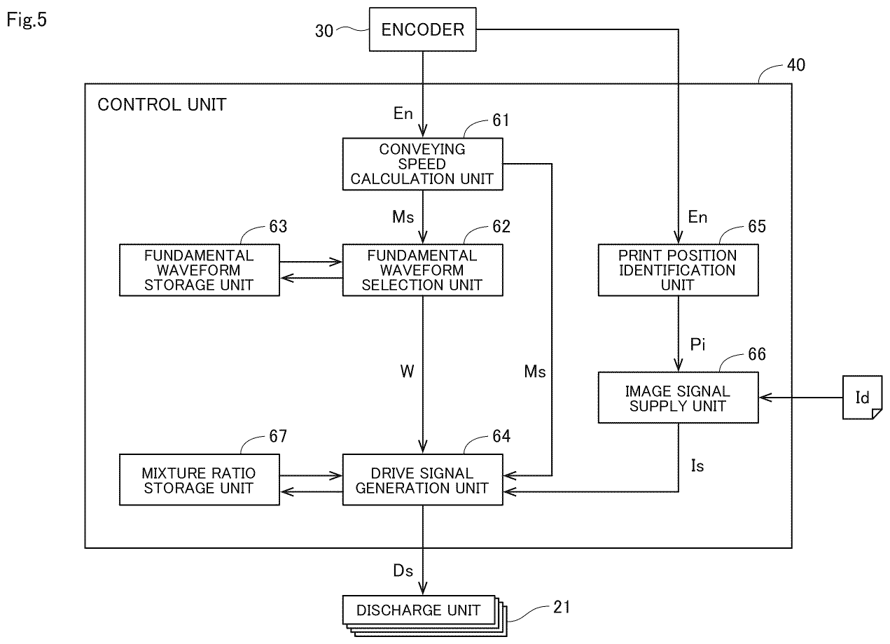

Next, a more detailed configuration of functions of the control unit 40 will be described. FIG. 5 is a block diagram conceptually showing some functions in the control unit 40. As shown in FIG. 5, the control unit 40 of the present embodiment includes a conveying-speed calculation unit 61, a fundamental-waveform selection unit 62, a fundamental-waveform storage unit 63, a drive signal generation unit 64, a print position identification unit 65, an image signal supply unit 66, and a mixture ratio storage unit 67. Functions of the conveying-speed calculation unit 61, the fundamental-waveform selection unit 62, the fundamental-waveform storage unit 63, the drive signal generation unit 64, the print position identification unit 65, the image signal supply unit 66, and the mixture ratio storage unit 67 are implemented by temporarily reading the computer program P and data D stored in the storage unit 43 into the memory 42, and performing, by the processor 41, arithmetic processing based on the computer program P and the data D.

As described above, the encoder 30 outputs the pulse signal En corresponding to the speed at which the continuous paper 9 conveyed by the conveyance mechanism 10 is conveyed, and supplies the pulse signal En to the control unit 40. On the basis of the supplied pulse signal En, the conveying-speed calculation unit 61 calculates a measurement value Ms (m/sec) of the speed at which the continuous paper 9 conveyed by the plurality of conveyance rollers 12 including the conveyance roller 121 is conveyed. That is, the conveying-speed calculation unit 61 detects the speed at which the continuous paper 9 related to the pulse signal En is conveyed. The conveying-speed calculation unit 61 corresponds to a “detection unit” in the first embodiment of the present invention. Furthermore, the conveying-speed calculation unit 61 supplies the calculated measurement value Ms of the speed at which the continuous paper 9 is conveyed to each of the fundamental-waveform selection unit 62 and the drive signal generation unit 64.

When the measurement value Ms of the speed at which the continuous paper 9 is conveyed is supplied from the conveying-speed calculation unit 61, the fundamental-waveform selection unit 62 queries the fundamental-waveform storage unit 63. The fundamental-waveform storage unit 63 stores a variable range of values of the speed at which the continuous paper 9 is conveyed and fundamental waveforms W corresponding to this in association with each other. Here, a fundamental waveform W is a minimum unit that constitutes the drive signal Ds. Furthermore, as described above, the drive signal Ds is a signal obtained by linking in time series drive voltages (pulsed waveforms) applied to the piezoelectric elements 82 to drive the piezoelectric elements 82 of the discharge unit 21. Furthermore, the fundamental waveform W is a drive voltage (pulsed waveform), and is a voltage applied to the piezoelectric elements 82 to discharge one ink droplet from the nozzle 83.

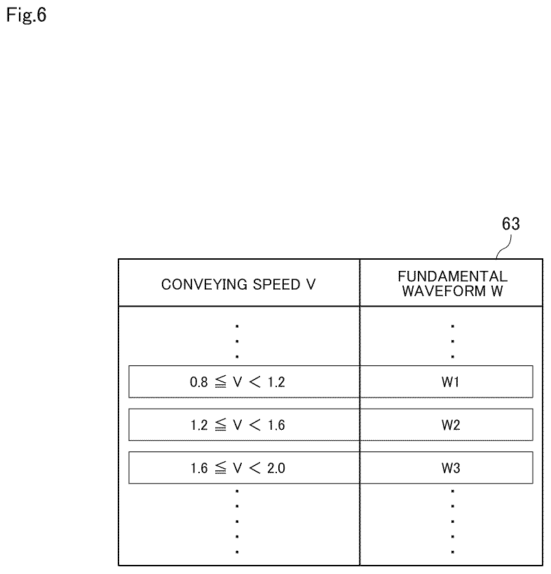

FIG. 6 is a diagram showing an example of fundamental waveforms W stored in the fundamental-waveform storage unit 63. As shown in FIG. 6, for example, a fundamental waveform W corresponding to a case where the speed V (m/sec) at which the continuous paper 9 is conveyed is “0.8≤V<1.2” is “W1”, and a fundamental waveform W corresponding to a case of “1.2≤V<1.6” is “W2”. The fundamental-waveform selection unit 62 reads a fundamental waveform W from the fundamental-waveform storage unit 63 based on the measurement value Ms of the speed at which the continuous paper 9 is conveyed, the measurement value Ms being supplied from the conveying-speed calculation unit 61, and supplies the fundamental waveform W to the drive signal generation unit 64.

Meanwhile, the print position identification unit 65 detects the position in the conveyance direction of the continuous paper 9 conveyed by the conveyance mechanism 10. Specifically, based on the pulse signal En supplied from the encoder 30, the print position identification unit 65 identifies a position where an image is to be printed on the continuous paper 9. Then, the print position identification unit 65 supplies the information of position Pi, which is an identified result, to the image signal supply unit 66.

The image signal supply unit 66 generates an image signal Is representing an image to be printed by each discharge unit 21, based on submitted image data Id and the information of position Pi on which the image is to be printed on the continuous paper 9, the information of position Pi being supplied from the print position identification unit 65. Specifically, the image signal supply unit 66 converts the submitted image data Id into images of color components of respective colors, cyan, magenta, yellow, and black, for example. Then, based on images of the color components of the respective colors, the image signal supply unit 66 recognizes at which positions on the continuous paper 9 the ink droplets of the respective colors, cyan, magenta, yellow, and black, should be discharged. Moreover, the image signal supply unit 66 determines a time at which these ink droplets should be discharged. That is, the image signal Is is time-series data obtained by linking data representing which discharge unit 21 discharges ink droplets of respective colors, cyan, magenta, yellow, and black, at which time.

Furthermore, the image signal supply unit 66 supplies the generated image signal Is to the drive signal generation unit 64. That is, the image signal supply unit 66 generates, based on the information of position Pi of the continuous paper 9, the information of position Pi being detected from the pulse signal En output from the encoder 30, the image signal Is representing an image to be printed at the respective discharge positions P1 to P4, and supplies the image signal Is to the drive signal generation unit 64.

The drive signal generation unit 64 generates the drive signal Ds for driving the piezoelectric element 82 and supplies the drive signal Ds to each of the four discharge units 21. Specifically, in a case where the measurement value Ms of the speed at which the continuous paper 9 is conveyed, the measurement value Ms being supplied from the conveying-speed calculation unit 61, is substantially constant, or in a case where a fluctuation range of the measurement value Ms of the conveying speed is within a predetermined range, the drive signal generation unit 64 generates the drive signal Ds by multiplying the fundamental waveform W corresponding to the measurement value Ms of the conveying speed by the image signal Is supplied from the image signal supply unit 66. More precisely, in a case where there is no change in the fundamental waveform W supplied from the fundamental-waveform selection unit 62, the drive signal generation unit 64 generates the drive signal Ds by multiplying the fundamental waveform W by the image signal Is supplied from the image signal supply unit 66.

On the basis of the drive signal Ds supplied from the drive signal generation unit 64, at the discharge positions P1 to P4, the four discharge units 21 discharge ink droplets of the respective colors from the nozzles 83 to appropriate positions in the conveyance direction on the continuous paper 9. As a result, each of the four discharge units 21 records a single-color image at an appropriate position on the recording surface of the continuous paper 9. Then, the four single-color images are superimposed, so that a high-quality multicolor image is formed on the upper surface of the continuous paper 9.

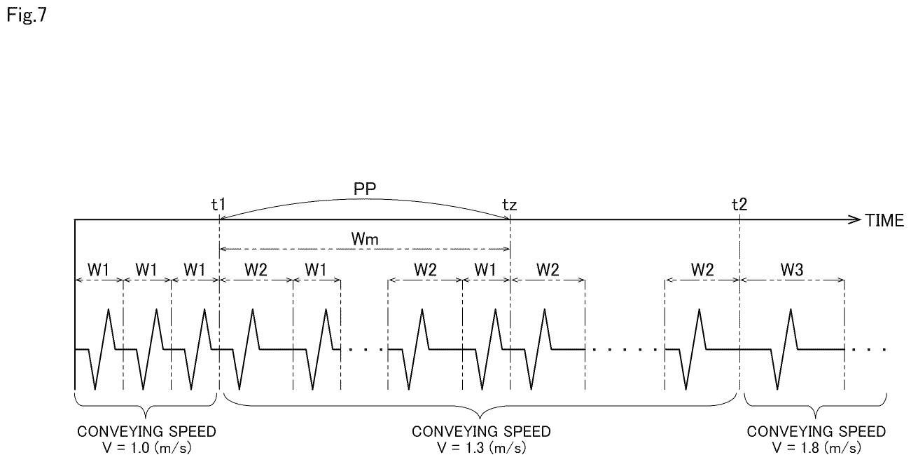

Here, it is assumed that the speed at which the continuous paper 9 is conveyed changes exceeding a first threshold value. For example, as shown in FIG. 7, it is assumed that, at time t1, the speed at which the continuous paper 9 is conveyed changes from the conveying speed V=1.0 (m/sec) to the conveying speed V=1.3 (m/sec). Here, the fundamental-waveform storage unit 63 stores settings in which the fundamental waveform W corresponding to a case where the speed V at which the continuous paper 9 is conveyed is “0.8≤V<1.2” is “W1”, and the fundamental waveform W corresponding to a case of “1.2≤V<1.6 ” is “W2”. Note that, in this case, the conveying speed V=1.2 (m/sec) is the first threshold value. Before the time t1, the fundamental-waveform selection unit 62 reads “pre-change fundamental waveforms W1” as the fundamental waveforms corresponding to the speed at which the continuous paper 9 is conveyed before the conveying speed is changed, and supplies the “pre-change fundamental waveforms W1” to the drive signal generation unit 64. Furthermore, at or after the time t1, the fundamental-waveform selection unit 62 reads “post-change fundamental waveforms W2” as the fundamental waveforms corresponding to the speed at which the continuous paper 9 is conveyed after the conveying speed is changed, and supplies the “post-change fundamental waveforms W2” to the drive signal generation unit 64.

Here, it is assumed that, before the time t1, the drive signal generation unit 64 generates the drive signal Ds by multiplying the pre-change fundamental waveforms W1 supplied from the fundamental-waveform selection unit 62 by the image signal Is supplied from the image signal supply unit 66. Then, it is assumed that each of the four discharge units 21 discharges an ink droplet of each color based on the drive signal Ds. Furthermore, it is assumed that, at or after the time t1, the drive signal generation unit 64 generates the drive signal Ds by multiplying the post-change fundamental waveforms W2 supplied from the fundamental-waveform selection unit 62 by the image signal Is supplied from the image signal supply unit 66. Then, it is assumed that each of the four discharge units 21 discharges an ink droplet of each color based on the drive signal Ds. Thus, in a case where waveforms of the drive signal Ds are immediately switched at the time t1, density of the ink printed on the continuous paper 9 as a print result may change at a switching boundary, and the boundary may appear as a streak.

Therefore, between the time t1 at which the drive signal Ds is switched and a time tz after the time t1, the drive signal generation unit 64 generates the drive signal Ds by multiplying a mixed waveform Wm of the pre-change fundamental waveforms W1 and the post-change fundamental waveforms W2 by the image signal Is supplied from the image signal supply unit 66. Here, the mixed waveform Wm is a waveform in which the pre-change fundamental waveforms W1 supplied before the time tl and the post-change fundamental waveforms W2 supplied at or after the time t1 are mixed. Note that the mixed waveform Wm is a waveform obtained by linking the pre-change fundamental waveforms W1 and the post-change fundamental waveforms W2 in time series at equal intervals or unequal intervals. That is, in a case where the speed at which the continuous paper 9 is conveyed changes exceeding the first threshold value at the time t1, in a predetermined period PP including the time point (time t1), the drive signal generation unit 64 generates the drive signal Ds by multiplying the mixed waveform Wm in which the pre-change fundamental waveforms W1 and the post-change fundamental waveforms W2 are mixed, by the image signal Is. Then, the drive signal generation unit 64 supplies the generated drive signal Ds to each of the four discharge units 21. As a result, by adopting a configuration in which the waveform of the drive signal Ds is not immediately switched, the boundary in printing is inconspicuous, and the print quality is improved.

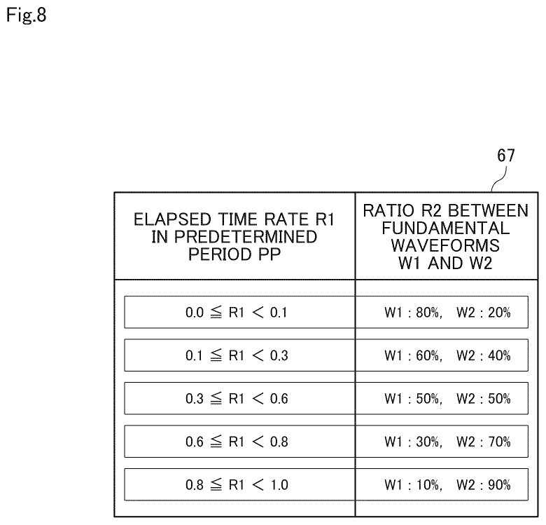

More specifically, upon recognizing that the measurement value Ms of the speed at which the continuous paper 9 is conveyed, the measurement value Ms being supplied from the conveying-speed calculation unit 61, has changed exceeding the first threshold value, the drive signal generation unit 64 queries the mixture ratio storage unit 67. Here, the mixture ratio storage unit 67 stores a variable range of values of an elapsed time rate R1 in the predetermined period PP described above, and a ratio R2 corresponding to this in association with each other. The ratio R2 is a ratio between the number of pre-change fundamental waveforms W1 and the number of post-change fundamental waveforms W2 that are included in the mixed waveform Wm. FIG. 8 is a diagram showing an example of the ratio R2 between the number of pre-change fundamental waveforms W1 and the number of post-change fundamental waveforms W2, the ratio R2 being included in the mixed waveform Wm stored in the mixture ratio storage unit 67.

For example, it is assumed that the predetermined period PP described above is “1.0 seconds”. The drive signal generation unit 64 mixes the fundamental waveforms W1 and W2 based on the mixture ratio R2 read from the mixture ratio storage unit 67. In this case, as shown in FIG. 8, in a period of 0.0 seconds to 0.1 seconds in the predetermined period PP, the drive signal generation unit 64 mixes the fundamental waveforms W1 and W2 included in the mixed waveform Wm such that a proportion of the number of pre-change fundamental waveforms W1 is 80% and a proportion of the number of post-change fundamental waveforms W2 is 20%. Similarly, in each of the other periods, the pre-change fundamental waveforms W1 and the post-change fundamental waveforms W2 are mixed at ratios R2 shown in FIG. 8. That is, the drive signal generation unit 64 generates the drive signal Ds by multiplying the mixed waveform Wm in which the pre-change fundamental waveforms W1 and the post-change fundamental waveforms W2 are mixed at the predetermined mixture ratio, by the image signal Is.

Furthermore, as shown in FIG. 8, in the predetermined period PP, the mixture ratio R2 of the pre-change fundamental waveforms W1 to the post-change fundamental waveforms W2 changes such that a proportion of the pre-change fundamental waveforms W1 gradually decreases and a proportion of the post-change fundamental waveforms W2 gradually increases. As a result, the boundary in printing becomes more inconspicuous, and the print quality is further improved. However, in the predetermined period PP, the mixture ratio R2 of the pre-change fundamental waveforms W1 to the post-change fundamental waveforms W2 may be different from the aspect in FIG. 8. The mixture ratio R2 may be maintained at a constant value throughout the predetermined period PP.

Here, the predetermined period PP described above will be described in detail. As shown in FIG. 7, it is assumed that the speed at which the continuous paper 9 is conveyed changes exceeding the first threshold value at the time t1 and then further changes exceeding a second threshold value at time t2. The second threshold value is a conveying speed at which the fundamental waveform W is switched from W2 to W3. In this case, the time tz, which is an end point of the predetermined period PP, is a time before a midpoint of a period between the time t1 and the time t2. That is, the predetermined period PP described above is a period before a middle of a period from a time point (time t1) at which the speed at which the continuous paper 9 is conveyed changes exceeding the first threshold value to a time point (time t2) at which the speed at which the continuous paper 9 is conveyed further changes exceeding the second threshold value. As a result, it is possible to sufficiently secure a period for generating the drive signal Ds only based on the post-change fundamental waveforms W2 instead of the mixed waveform Wm, before reaching the time t2.

However, the predetermined period PP may be set longer than the predetermined period PP as described above. Furthermore, the predetermined period PP may be set before the time t1. That is, in a case where it is known in advance that the speed at which the continuous paper 9 is conveyed changes exceeding the first threshold value at the time t1, the drive signal Ds may be generated by using the mixed waveform Wm before the change.

As described above, in the present embodiment, a period is provided to discharge, when switching a waveform of the drive signal Ds supplied to the discharge units 21 according to a change in the speed at which the continuous paper 9 is conveyed, the ink droplets according to the drive signal Ds generated by using the mixed waveform Wm in which the pre-change fundamental waveforms W1 and the post-change fundamental waveforms W2 are mixed. As a result, the boundary in printing is inconspicuous before and after the switching, and the print quality can be improved. Furthermore, for the respective pre-change fundamental waveforms W1 and post-change fundamental waveforms W2 that are included in the mixed waveform Wm, it has already been confirmed that the ink droplets are appropriately discharged in a case where the discharge units 21 are driven by the drive signal Ds generated by them. Therefore, appropriate discharge of the ink droplets can be ensured by using the mixed waveform Wm in which such known fundamental waveforms W1 and W2 are mixed. That is, by using the mixed waveform Wm in which the fundamental waveforms W1 and W2 are mixed, without changing the fundamental waveforms W1 and W2 themselves, the ink droplets can be more appropriately discharged than in a case where the fundamental waveforms W1 and W2 themselves are changed. As a result, the print quality can be further improved.

### 2. Second Embodiment

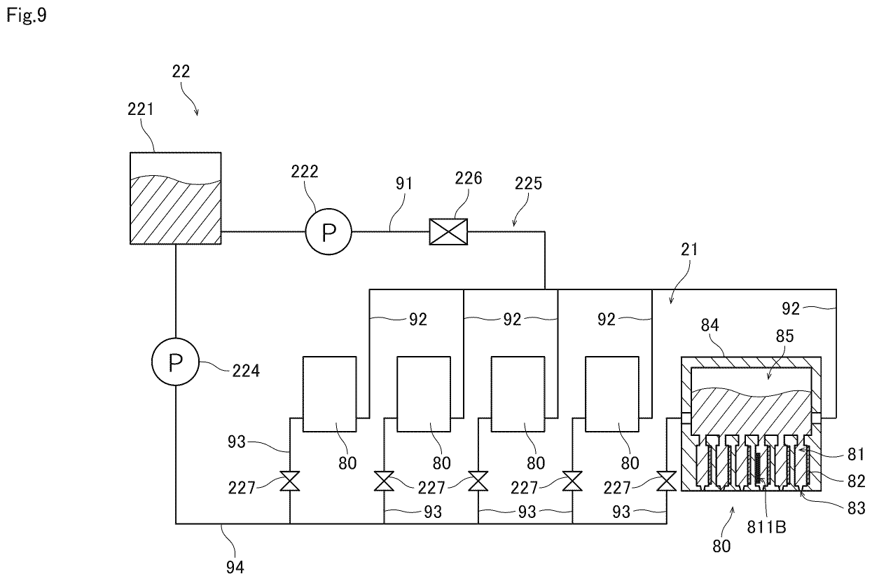

Next, a configuration of an inkjet printing apparatus 1 according to a second embodiment of the present invention will be described. Note that, hereinafter, differences from the first embodiment will be mainly described, and redundant description of parts equivalent to those of the first embodiment will be partially omitted. FIG. 9 is a diagram conceptually showing a configuration of one discharge unit 21 and one ink supply unit 22 according to the present embodiment.

As shown in FIG. 9, in the inkjet printing apparatus 1 according to the present embodiment, a temperature detection unit 811B for measuring a temperature of ink in an ink chamber 81 is provided in an ink chamber 81 of each discharge unit 21. The temperature detection unit 811B corresponds to a “detection unit” in the second embodiment of the present invention. The temperature detection unit 811B measures the temperature of the ink in the ink chamber 81 and outputs a measurement value Dt related to a detection result. The measurement value Dt is transmitted from the temperature detection unit 811B to a control unit 40.

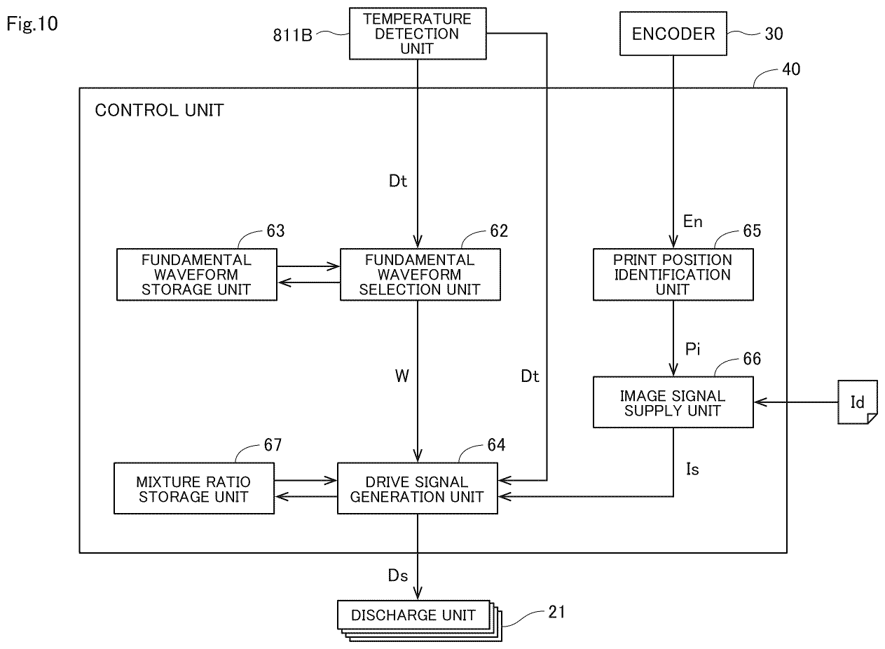

FIG. 10 is a block diagram conceptually showing some functions in the control unit 40 according to the present embodiment. As shown in FIG. 10, the control unit 40 of the present embodiment includes a fundamental-waveform selection unit 62, a fundamental-waveform storage unit 63, a drive signal generation unit 64, a print position identification unit 65, an image signal supply unit 66, and a mixture ratio storage unit 67.

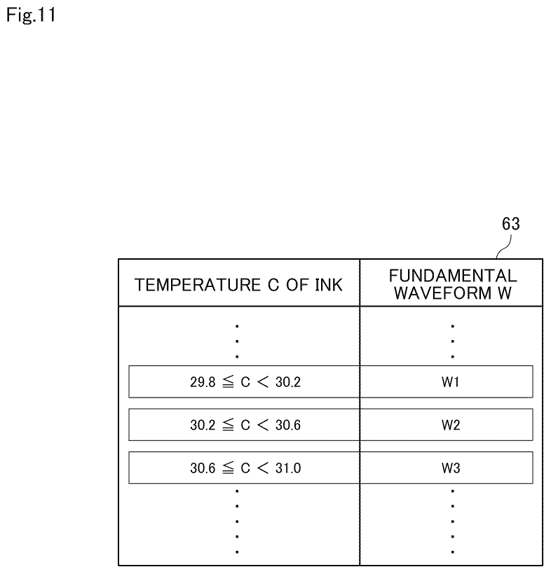

When the measurement value Dt of the temperature of the ink in the ink chamber 81 is supplied from the temperature detection unit 811B, the fundamental-waveform selection unit 62 queries the fundamental-waveform storage unit 63. The fundamental-waveform storage unit 63 stores a variable range of values of the temperature of the ink in the ink chamber 81 and a fundamental waveforms W corresponding to this in association with each other. Here, a fundamental waveform W is a minimum unit that constitutes the drive signal Ds for driving a piezoelectric element 82. FIG. 11 is a diagram showing an example of the fundamental waveforms W stored in the fundamental-waveform storage unit 63 according to the present embodiment. As shown in FIG. 11, for example, the fundamental waveform W corresponding to a case where a temperature C (C) of the ink in the ink chamber 81 is “29.8≤C<30.2” is “W1”, and the fundamental waveform W corresponding to a case of “30.2≤C<30.6” is “W2”. The fundamental-waveform selection unit 62 reads the fundamental waveform W from the fundamental-waveform storage unit 63 based on the measurement value Dt of the temperature of the ink in the ink chamber 81, the measurement value Dt being supplied from the temperature detection unit 811B, and supplies the fundamental waveform W to the drive signal generation unit 64.

Meanwhile, the print position identification unit 65 detects the position in the conveyance direction of the continuous paper 9 conveyed by the conveyance mechanism 10. Specifically, based on the pulse signal En supplied from the encoder 30, the print position identification unit 65 identifies a position where an image is to be printed on the continuous paper 9. Then, the print position identification unit 65 supplies the information of position Pi, which is an identified result, to the image signal supply unit 66.

The image signal supply unit 66 generates an image signal Is representing an image to be printed by each discharge unit 21, based on submitted image data Id and the information of position Pi on which the image is to be printed on the continuous paper 9, the information of position Pi being supplied from the print position identification unit 65. That is, the image signal supply unit 66 generates, based on the information of position Pi of the continuous paper 9, the information of position Pi being detected from the pulse signal En output from the encoder 30, the image signal Is representing an image to be printed at the respective discharge positions P1 to P4, and supplies the image signal Is to the drive signal generation unit 64.

The drive signal generation unit 64 generates the drive signal Ds for driving the piezoelectric element 82 and supplies the drive signal Ds to each of the four discharge units 21. Specifically, in a case where the measurement value Dt of the temperature of the ink in the ink chamber 81, the measurement value Dt being supplied from the temperature detection unit 811B, is substantially constant, or in a case where a fluctuation range of the measurement value Dt of the temperature of the ink is within a predetermined range, the drive signal generation unit 64 generates the drive signal Ds by multiplying the fundamental waveform W corresponding to the measurement value Dt of the temperature of the ink by the image signal Is supplied from the image signal supply unit 66. More precisely, in a case where there is no change in the fundamental waveform W supplied from the fundamental-waveform selection unit 62, the drive signal generation unit 64 generates the drive signal Ds by multiplying the fundamental waveform W by the image signal Is supplied from the image signal supply unit 66.

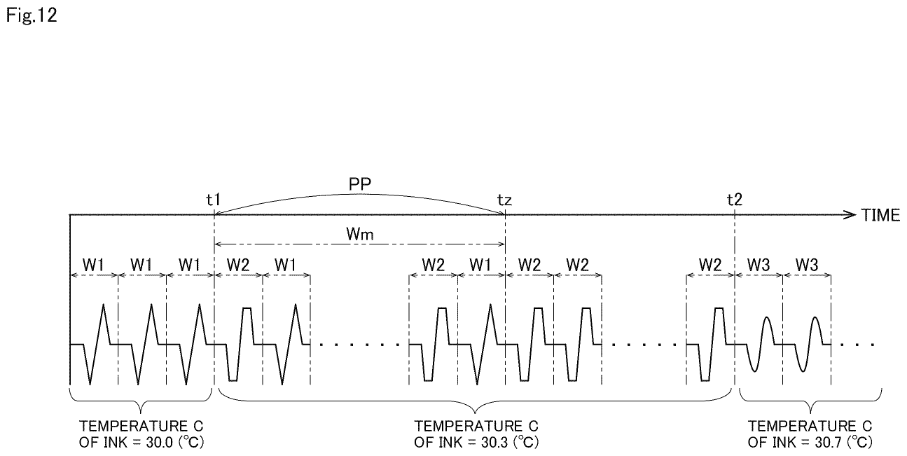

Here, it is assumed that the temperature of the ink in the ink chamber 81 changes exceeding a first threshold value. For example, as shown in FIG. 12, it is assumed that, at time t1, the temperature of the ink in the ink chamber 81 changes from the temperature C=30.0 (C) to the temperature C=30.3 (C). Here, the fundamental-waveform storage unit 63 stores settings in which the fundamental waveform W corresponding to a case where the temperature C (C) of the ink in the ink chamber 81 is “29.8≤C<30.2” is “W1”, and the fundamental waveform W corresponding to a case of “30.2≤C<30.6” is “W2”. Note that, in this case, the temperature C=30.2 (°C) is the first threshold value. Before the time t1, the fundamental-waveform selection unit 62 reads “pre-change fundamental waveforms W1” as the fundamental waveforms W corresponding to the temperature of the ink in the ink chamber 81 before the temperature is changed, and supplies the “pre-change fundamental waveforms W1” to the drive signal generation unit 64. Furthermore, at or after the time t1, the fundamental-waveform selection unit 62 reads “post-change fundamental waveforms W2” as the fundamental waveforms W corresponding to the temperature of the ink in the ink chamber 81 after the temperature is changed, and supplies the “post-change fundamental waveforms W2” to the drive signal generation unit 64.

Here, between the time t1 at which the drive signal Ds is switched and a time tz after the time t1, the drive signal generation unit 64 generates the drive signal Ds by multiplying a mixed waveform Wm of the pre-change fundamental waveforms W1 and the post-change fundamental waveforms W2 by the image signal Is supplied from the image signal supply unit 66. Here, the mixed waveform Wm is a waveform in which the pre-change fundamental waveforms W1 supplied before the time tl and the post-change fundamental waveforms W2 supplied at or after the time t1 are mixed. That is, in a case where the speed at which the continuous paper 9 is conveyed changes exceeding the first threshold value at the time t1, in a predetermined period PP including the time point (time t1), the drive signal generation unit 64 generates the drive signal Ds by multiplying the mixed waveform Wm in which the pre-change fundamental waveforms W1 and the post-change fundamental waveforms W2 are mixed, by the image signal Is. Then, the drive signal generation unit 64 supplies the generated drive signal Ds to each of the four discharge units 21. As a result, by adopting a configuration in which the waveform of the drive signal Ds is not immediately switched, the boundary in printing is inconspicuous, and the print quality is improved.

More specifically, upon recognizing that the measurement value Dt of the temperature of the ink in the ink chamber 81, the measurement value Dt being supplied from the temperature detection unit 811B, has changed exceeding the first threshold value, the drive signal generation unit 64 queries the mixture ratio storage unit 67. Here, similarly to FIG. 8 of the first embodiment described above, the mixture ratio storage unit 67 stores a variable range of values of an elapsed time rate R1 in the predetermined period PP described above, and a ratio R2 corresponding to this in association with each other. The ratio R2 is a ratio between the number of pre-change fundamental waveforms W1 and the number of post-change fundamental waveforms W2 that are included in the mixed waveform Wm. The drive signal generation unit 64 generates the drive signal Ds by multiplying the mixed waveform Wm in which the pre-change fundamental waveforms W1 and the post-change fundamental waveforms W2 are mixed at the predetermined mixture ratio stored in the mixture ratio storage unit 67, by the image signal Is.

Furthermore, similarly to the first embodiment, in the predetermined period PP, the mixture ratio R2 of the pre-change fundamental waveforms W1 to the post-change fundamental waveforms W2 changes such that a proportion of the pre-change fundamental waveforms W1 gradually decreases and a proportion of the post-change fundamental waveforms W2 gradually increases. As a result, the boundary in printing becomes more inconspicuous, and the print quality is further improved. However, in the predetermined period PP, the mixture ratio R2 of the pre-change fundamental waveforms W1 to the post-change fundamental waveforms W2 may be different from the aspect described above. The mixture ratio R2 may be maintained at a constant value.

Furthermore, similarly to the first embodiment, as shown in FIG. 12, it is assumed that the temperature of the ink in the ink chamber 81 changes exceeding the first threshold value at the time t1 and then further changes exceeding a second threshold value at time t2. The second threshold value is a temperature at which the fundamental waveform W is switched from W2 to W3. In this case, the time tz, which is an end point of the predetermined period PP, is a time before a midpoint of a period between the time tl and the time t2. That is, the predetermined period PP described above is a period before a middle of a period from a time point (time t1) at which the temperature of the ink in the ink chamber 81 changes exceeding the first threshold value to a time point (time t2) at which the temperature of the ink in the ink chamber 81 further changes exceeding the second threshold value. As a result, it is possible to sufficiently secure a period for generating the drive signal Ds only based on the post-change fundamental waveforms W2 instead of the mixed waveform Wm, before reaching the time t2.

However, the predetermined period PP may be set longer than the predetermined period PP as described above. Furthermore, the predetermined period PP may be set before the time t1. That is, in a case where it is known in advance that the temperature of the ink in the ink chamber 81 changes exceeding the first threshold value at the time t1, the drive signal Ds may be generated by using the mixed waveform Wm before the change.

As described above, in the present embodiment, a period is provided to discharge, when switching a waveform of the drive signal Ds supplied to the discharge units 21 according to a change in the temperature of the ink in the ink chamber 81, the ink droplets according to the drive signal Ds generated by using the mixed waveform Wm in which the pre-change fundamental waveforms W1 and the post-change fundamental waveforms W2 are mixed. As a result, the boundary in printing is inconspicuous before and after the switching, and the print quality can be improved. Furthermore, for the respective pre-change fundamental waveforms W1 and post-change fundamental waveforms W2 that are included in the mixed waveform Wm, it has already been confirmed that the ink droplets are appropriately discharged in a case where the discharge units 21 are driven by the drive signal Ds generated by them. Therefore, appropriate discharge of the ink droplets can be ensured by using the mixed waveform Wm in which such known fundamental waveforms W1 and W2 are mixed. That is, by using the mixed waveform Wm in which the fundamental waveforms W1 and W2 are mixed, without changing the fundamental waveforms W1 and W2 themselves, the ink droplets can be more appropriately discharged than in a case where the fundamental waveforms W1 and W2 themselves are changed. As a result, the print quality can be further improved.

### 3. Modifications

While the first and second embodiments according to the present invention have been described hereinabove, the present invention is not limited to the aforementioned embodiments.

As described above, an inkjet printing apparatus that performs printing on a printing medium with an inkjet method is only required to include a conveyance mechanism that conveys the printing medium in a longitudinal direction along a conveyance path, an encoder that outputs a pulse signal corresponding to a speed at which the printing medium conveyed by the conveyance mechanism is conveyed, a discharge unit that includes a nozzle that discharges, at a discharge position on the conveyance path, an ink droplet onto the printing medium conveyed by the conveyance mechanism, an ink chamber communicating with the nozzle, and a piezoelectric element that applies pressure to ink in the ink chamber, a drive signal generation unit that generates a drive signal for driving the piezoelectric element and supplies the drive signal to the discharge unit, an image signal supply unit that generates, based on the information of position of the printing medium, the information of position being detected from the pulse signal output from the encoder, an image signal representing an image to be printed at the discharge position, and supplies the image signal to the drive signal generation unit, a detection unit that detects one of a speed at which the printing medium related to the pulse signal is conveyed or a temperature of ink in the ink chamber, a fundamental-waveform storage unit that stores a variable range of values of the one of a speed at which the printing medium is conveyed or a temperature of ink in the ink chamber, and a fundamental waveform corresponding to this in association with each other, and a fundamental-waveform selection unit that reads the fundamental waveform from the fundamental-waveform storage unit based on a result of detecting, by the detection unit, the one of a speed at which the printing medium is conveyed or a temperature of ink in the ink chamber, and supplies the fundamental waveform to the drive signal generation unit. Then, the drive signal generation unit is only required to generate, in a case where the one of a speed at which the printing medium is conveyed or a temperature of ink in the ink chamber changes exceeding a first threshold value, in a predetermined period including the time point, the drive signal by multiplying a mixed waveform in which a pre-change fundamental waveform that is the fundamental waveform corresponding to the one of a speed at which the printing medium is conveyed before the conveying speed is changed or a temperature of ink in the ink chamber before the temperature is changed and a post-change fundamental waveform that is the fundamental waveform corresponding to the one of a speed at which the printing medium is conveyed after the conveying speed is changed or a temperature of ink in the ink chamber after the temperature is changed are mixed, by the image signal, and supplies the drive signal to the discharge unit.

Furthermore, in a case where the one of a speed at which the printing medium is conveyed or a temperature of ink in the ink chamber changes exceeding the first threshold value, and then further changes exceeding a second threshold value, the predetermined period is more preferably a period before a middle of a period from a time point at which the one of a speed at which the printing medium is conveyed or a temperature of ink in the ink chamber changes exceeding the first threshold value to a time point at which the one of the speed at which the printing medium is conveyed or the temperature of ink in the ink chamber further changes exceeding the second threshold value.

Furthermore, the “one” may be the speed at which the printing medium is conveyed, or may be the temperature of the ink in the ink chamber.

Furthermore, the components described in the aforementioned embodiments and in the modifications may be combined together, as appropriate, as long as contradictions are avoided.

### REFERENCE SIGNS LIST

1 inkjet printing apparatus
9 continuous paper
10 conveyance mechanism
12 conveyance roller
20 printing unit
21 discharge unit
22 ink supply unit
30 encoder
40 control unit
61 conveying-speed calculation unit
62 fundamental-waveform selection unit
63 fundamental-waveform storage unit
64 drive signal generation unit
65 print position identification unit
66 image signal supply unit
67 mixture ratio storage unit
80 head
81 ink chamber
82 piezoelectric element
83 nozzle
121 conveyance roller
811B temperature detection unit
Ds drive signal
Dt measurement value (of temperature of ink)
En pulse signal (of encoder)
Is image signal
Ms measurement value (of speed at which continuous paper is conveyed)
PP predetermined period (using mixed waveform)
Pi information of position
V conveying speed (of continuous paper)
W1 pre-change fundamental waveform
W2 post-change fundamental waveform
Wm mixed waveform

1. An inkjet printing apparatus that performs printing on a printing medium with an inkjet method, the inkjet printing apparatus comprising:
a conveyance mechanism that conveys the printing medium in a longitudinal direction along a conveyance path;
an encoder that outputs a pulse signal corresponding to a speed at which the printing medium conveyed by the conveyance mechanism is conveyed;
a discharge unit that includes a nozzle that discharges, at a discharge position on the conveyance path, an ink droplet onto the printing medium conveyed by the conveyance mechanism, an ink chamber communicating with the nozzle, and a piezoelectric element that applies pressure to ink in the ink chamber;
a drive signal generation unit that generates a drive signal for driving the piezoelectric element and supplies the drive signal to the discharge unit;
an image signal supply unit that generates, based on information of position of the printing medium, the information of position being detected from the pulse signal output from the encoder, an image signal representing an image to be printed at the discharge position, and supplies the image signal to the drive signal generation unit;
a detection unit that detects one of a speed at which the printing medium related to the pulse signal is conveyed or a temperature of ink in the ink chamber;
a fundamental-waveform storage unit that stores a variable range of values of the one of a speed at which the printing medium is conveyed or a temperature of ink in the ink chamber, and a fundamental waveform corresponding to the variable range of values in association with each other; and
a fundamental-waveform selection unit that reads the fundamental waveform from the fundamental-waveform storage unit based on a result of detecting, by the detection unit, the one of a speed at which the printing medium is conveyed or a temperature of ink in the ink chamber, and supplies the fundamental waveform to the drive signal generation unit, wherein
in a case where the one of a speed at which the printing medium is conveyed or a temperature of ink in the ink chamber changes exceeding a first threshold value, in a predetermined period including the time point,
the drive signal generation unit
generates the drive signal by multiplying a mixed waveform in which
a pre-change fundamental waveform that is the fundamental waveform corresponding to the one of a speed at which the printing medium is conveyed before the conveying speed is changed or a temperature of ink in the ink chamber before the temperature is changed and a post-change fundamental waveform that is the fundamental waveform corresponding to the one of a speed at which the printing medium is conveyed after the conveying speed is changed or a temperature of ink in the ink chamber after the temperature is changed
are mixed, by the image signal, and supplies the drive signal to the discharge unit.

2. The inkjet printing apparatus according to claim 1, wherein
the drive signal generation unit generates the drive signal by multiplying the mixed waveform in which the pre-change fundamental waveform and the post-change fundamental waveform are mixed at a predetermined mixture ratio, by the image signal.

3. The inkjet printing apparatus according to claim 1, wherein
in a case where the one of a speed at which the printing medium is conveyed or a temperature of ink in the ink chamber changes exceeding the first threshold value, and then further changes exceeding a second threshold value,
the predetermined period is a period before a middle of a period from a time point at which the one of a speed at which the printing medium is conveyed or a temperature of ink in the ink chamber changes exceeding the first threshold value to a time point at which the one of the speed at which the printing medium is conveyed or the temperature of ink in the ink chamber further changes exceeding the second threshold value.

4. The inkjet printing apparatus according to claim 2, wherein
in the predetermined period, the mixture ratio changes such that a proportion of the pre-change fundamental waveform gradually decreases and a proportion of the post-change fundamental waveform gradually increases.

5. The inkjet printing apparatus according to claim 1, wherein the one is a speed at which the printing medium is conveyed.

6. The inkjet printing apparatus according to claim 1, wherein the one is a temperature of ink in the ink chamber.
